(19) United States
(12) Patent Application Publication
(10) Pub. No.: US 2023/0046760 A1
(43) Pub. Date: Feb. 16, 2023

(54) Compound Flossing Apparatus

(71) Applicant: Vincent Paul Jalbert, East Lyme, CT (US)

(72) Inventor: Vincent Paul Jalbert, East Lyme, CT (US)

(21) Appl. No.: 17/703,477

(22) Filed: Mar. 24, 2022

Related U.S. Application Data
(63) Continuation-in-part of application No. 17/445,191, filed on Aug. 16, 2021, now Pat. No. 11,284,977.

(51) Int. Cl. A61C 15/04

(52) U.S. Cl. CPC A61C 15/046

(57) ABSTRACT

A disposable apparatus for flossing teeth employs a loop of dental floss that has a compound, bidirectional floss movement. A hinged lever tab on the device's frame can be pivoted by hand to move the floss loop.

### TECHNICAL FIELD

The invention relates in general to dental instruments, and more specifically to structures for holding, dispensing and manipulating dental floss.

### BACKGROUND

Disposable dental flossers hold a short length of dental floss between two fixed points. These flossers enable people with or without physical limitations to floss their teeth and/or to floss more easily, and possibly more often, than they otherwise would.

Flossing involves the removal of trapped food particles from between the teeth and plaque from around the base of the teeth. Traditional, disposable flossing devices enable flossing in only one direction at a time, with a limited length of floss. Limited maneuvering room further limits the length of the stroke. A floss loop that moves simultaneously moves in opposing directions between teeth would provide effective removal of food particles and plaque.

### SUMMARY

A disposable apparatus for flossing teeth employs a loop of dental floss that can be operated to provide compound floss motion between the teeth to remove trapped food particles. A hinged lever tab on the device's frame can be pivoted by hand to simultaneously move crossed floss segments in opposing directions between the teeth. The simultaneously bidirectional motion of the two floss segments tears and dislodges food particles. In some iterations, the floss segments may be twisted.

### BRIEF DESCRIPTION OF THE DRAWINGS

FIG. 1 is a perspective view of an iteration 100.

FIG. 2A is a detail, front view from which a cross section, 2B, is taken.

FIG. 2B is a detail, cross-section view.

FIG. 3 is a perspective, partially exploded detail view of a pivot point of iteration 100.

FIG. 4 is a perspective view of the lever tab portion of iteration 100.

FIG. 5 is a perspective view of iteration 100 illustrating floss motion.

FIG. 6 is a perspective view of iteration 100 in a position for flossing lower teeth.

FIG. 7 is a perspective view of iteration 100 in a position for flossing upper teeth.

FIG. 8 is a perspective view of a second iteration 200 of the embodiment.

### DESCRIPTION

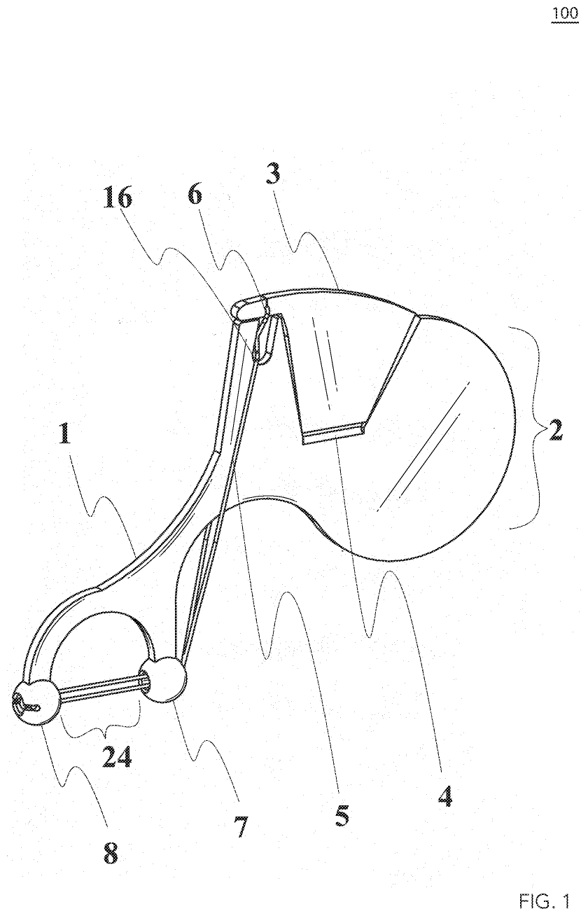

FIG. 1 shows iteration 100 with floss in a relaxed state. The invention is constructed with a frame 1 and a loop 5 of dental floss. Two ends of the floss loop 5 are looped through a paddle-shaped lever tab 3 at an anchor point 6, also referred to as a dual anchor point 6. The paddle-shaped lever tab 3 connects to the frame 1 with a living hinge 4. The paddle-shaped lever tab 3 can be pivoted laterally on the axis of its hinge. One skilled in the art understands that a “lever tab” or any lever can be configured to slide or rotate like a wheel.

The frame 1 includes a holding section 2. A first ball-shaped floss guide 7 and second ball-shaped floss guide 8 are disposed at two terminals of the frame 1. These floss guides 7 and 8 define the boundaries of a flossing section 24. The frame 1 further includes a floss-fulcrum channel 16 to control and leverage the movement of the floss loop 5.

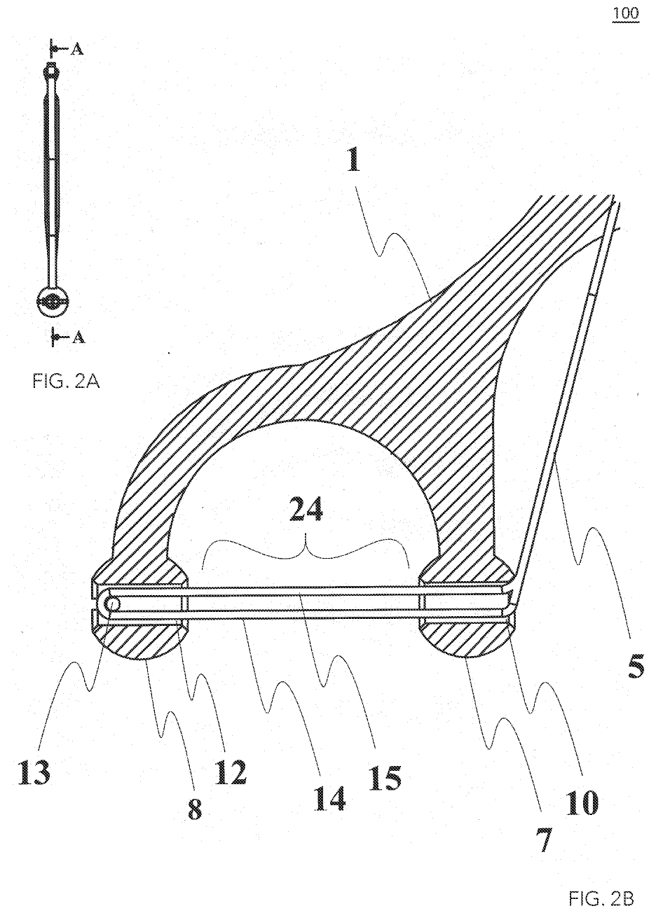

FIG. 2A is a detail, front view from which a cross section, 2B, is taken. In section view, FIG. 2B shows the floss loop's 5 route through the flossing section 24. Both first floss guide 7 and the second floss guide 8 have channels 10, 12 through which the floss is routed. The floss is directed around a pivot point 13. Upper 15 and lower 14 segments of the floss loop 5 are shown parallel in the flossing section 24. Both floss segments 14, 15 and pivot point 13 together effect a mechanism like a looped clothesline; pulling the floss loop 5 moves upper floss segment 15 and lower floss segment 14 in opposition. This compound motion aides in-removing trapped food particles from between the teeth.

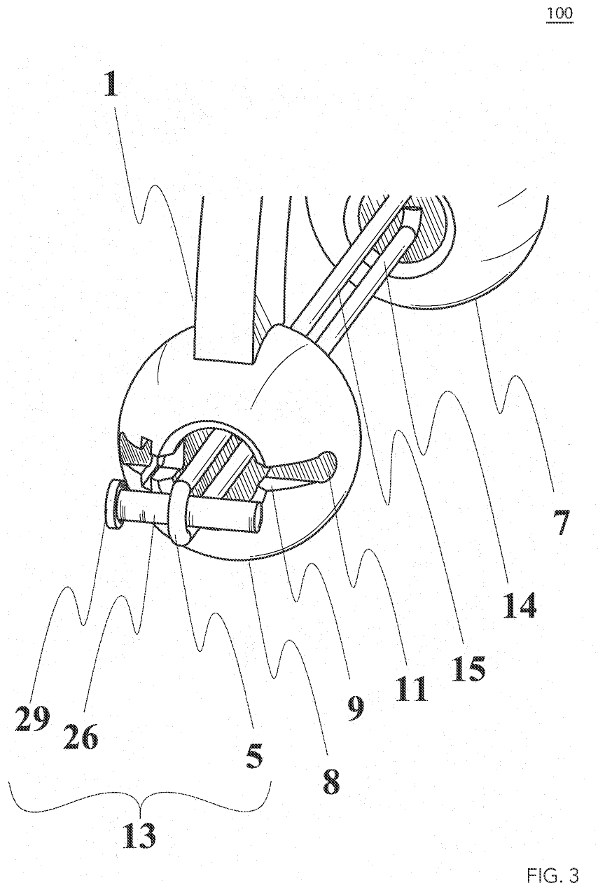

In an exploded, detail view, FIG. 3 shows the pivot point 13 implemented as a pulley in the second ball-shaped floss guide 8. In an example embodiment the pulley-floss pivot point 13 includes a pin 26 that rotates in a channel 11 within the second ball-shaped floss guide 8. The floss loop 5 is shown wrapped around the pin 26 which is shown disassembled. The pin 26 has a head 29 to prevent lateral sliding of the pin 26 in the channel 11. The second floss guide 8 includes an entry cavity 9 with space to accommodate the pin head 29 as well as a tapered and captive entry port for the pin 26.

One skilled in the art of molded plastic parts may devise any number of pivot-point 13 mechanisms to serve the same function.

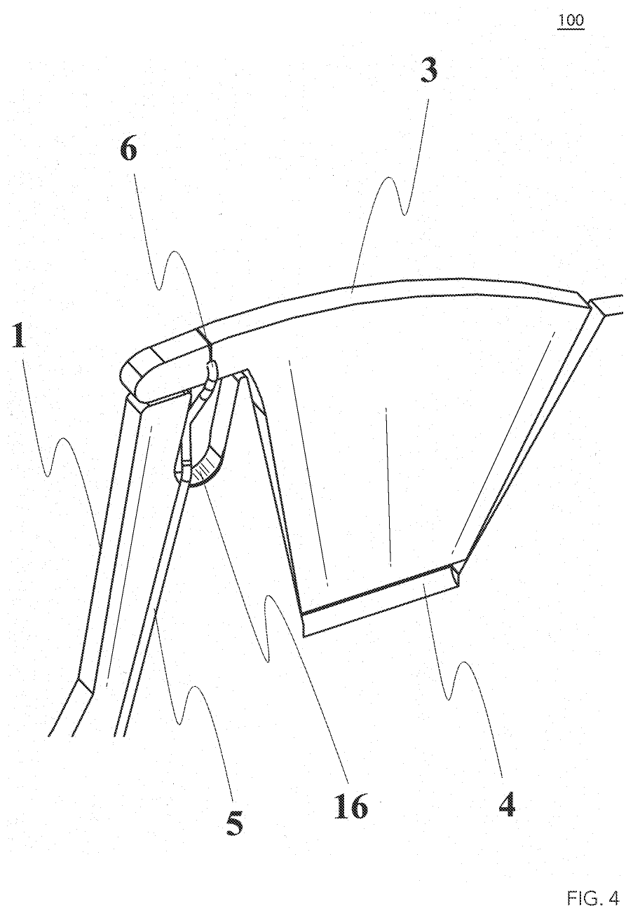

FIG. 4 is a perspective view of the floss loop 5 routing through the lever tab 3. The floss loop 5 traverses upward along the frame 1 and through the floss fulcrum channel 16, where it crosses and then loops through the dual anchor point 6.

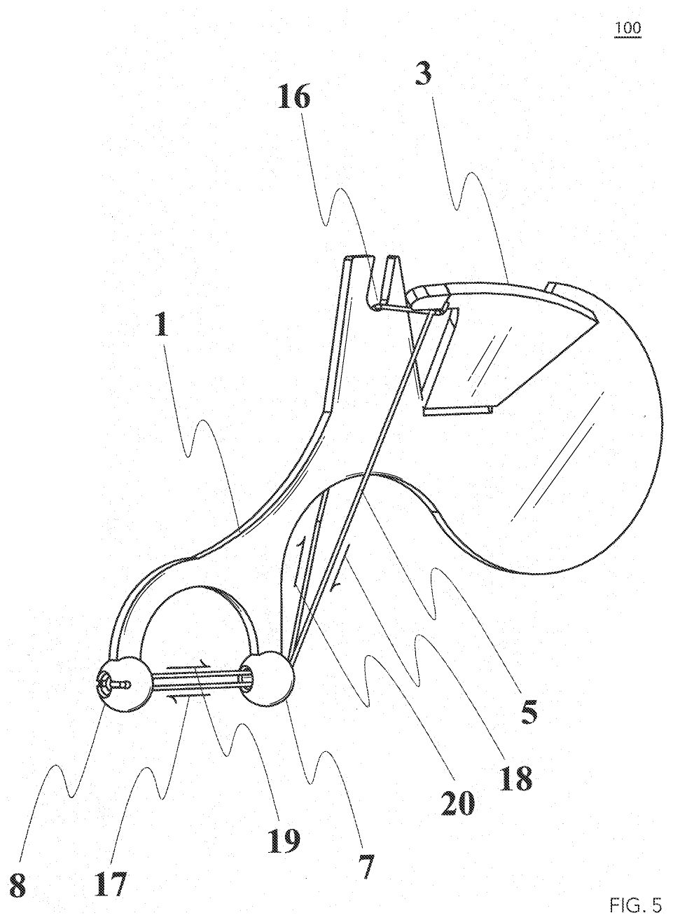

FIG. 5 shows the motion of the floss loop. Pushing lever tab 3 with a finger to one side or the other pulls the floss through the floss fulcrum channel 16, directing the floss loop 5 to slide down one side, across the flossing section FIG. 1, 24. and up the other side, as shown by direction arrows 18 and 20. The simultaneous, bidirectional sliding of the floss in the flossing section FIG. 1, 24 creates a compound motion as indicated by direction arrows 17 and 19 which applies shearing force to break up and dislodge food particles from between teeth. The lever tab 3 can be moved back and forth to assist in the cleaning process. As food particles fall between floss segments 14 and 15, shearing and rotational forces break up and dislodge them. The relative velocity between the upper and lower floss segments FIG. 2, 14, 15 is twice the linear velocity of the floss loop 5. This faster movement removes food particles more effectively.

Pivoting the lever tab 3 to about 60 degrees from the center axis results in a linear displacement of the floss loop 5 in the flossing section 24 equal to the length of the flossing section 24. The stroke length of the upper and lower floss segments FIG. 2, 14, 15 is two to three times longer than in similar devices in the art. Pivoting the lever tab 3 from side to side causes some incidental stretching of the floss. Some stretching of the floss loop is desirable to assist with the floss-insertion process. One skilled in the art understands that varying arrangements of the floss-fulcrum channel 16 cause varying amounts of floss stretching. One skilled in the art also understands that the lever tab 3 may employ other mechanisms known in the art, including that of a detachable motorized handle similar to that of an electric toothbrush with a detachable and disposable flossing head.

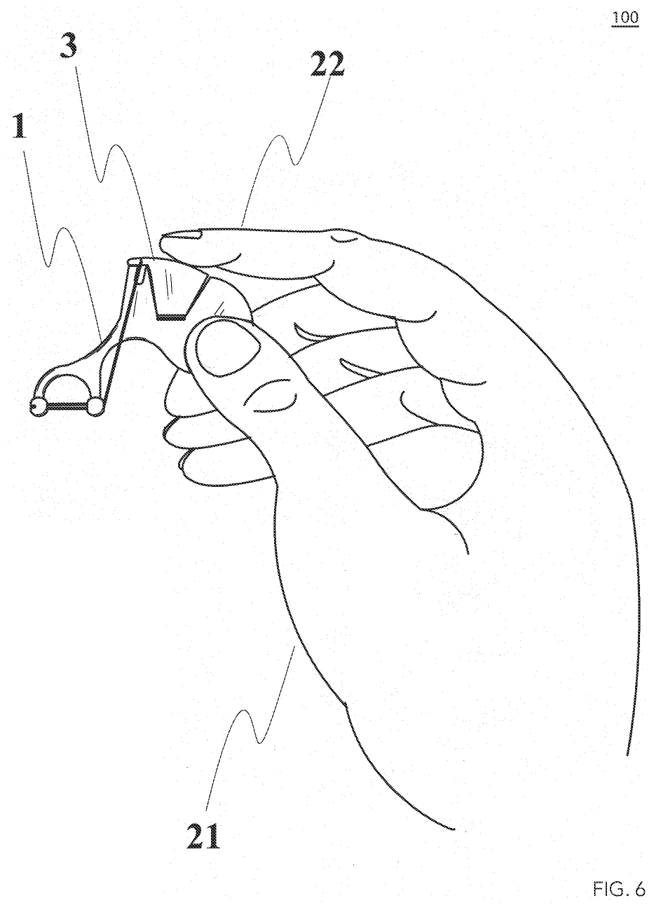

FIG. 6 shows a suggested angle for using the embodiment when flossing lower teeth. The frame 1 is held by the hand 21 and the lever tab 3 is operated by the index finger 22.

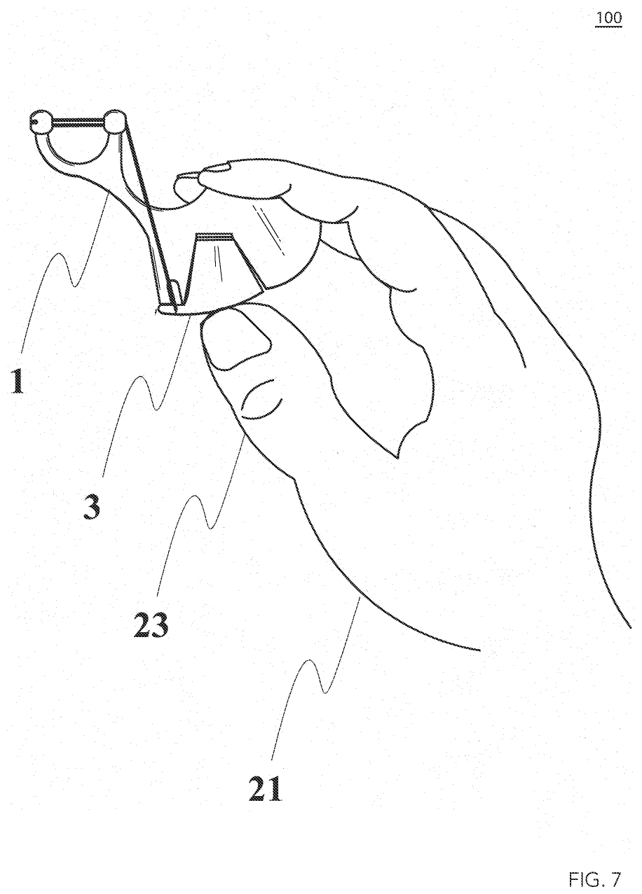

FIG. 7 shows a suggested angle for using the embodiment when flossing upper teeth. The frame 1 is held by the hand 21 and the lever tab 3 is operated by the thumb 23.

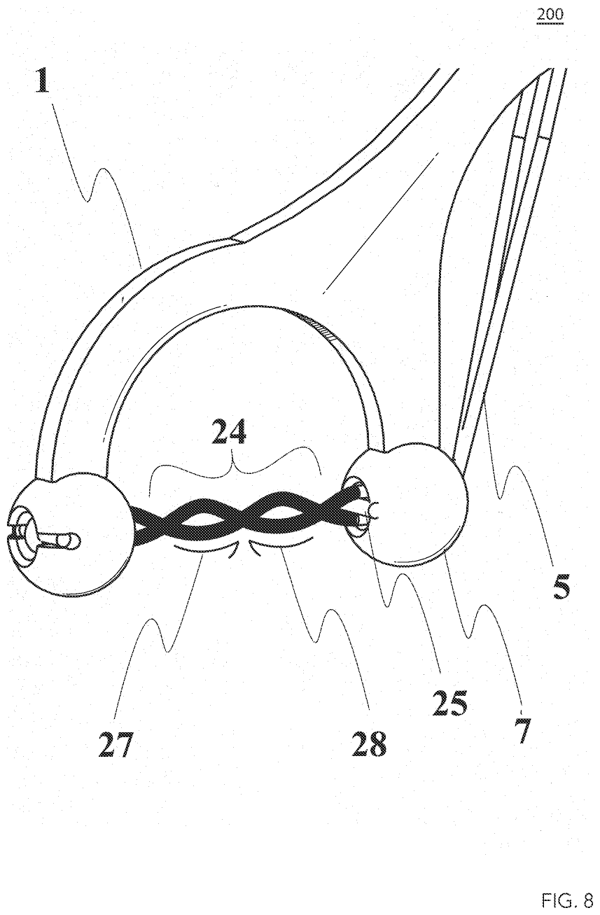

FIG. 8 shows a separate iteration 200 in which the upper floss segment 15 and the lower floss segment 14 are twisted in the flossing section 24. The edges travel in opposing directions (arrows 27 and 28) in a movement like that of a flexible drill bit with edges that move simultaneously in opposite directions. A floss-channel separator 25 attached to the first floss guide 7 maintains the floss's twisting in the flossing section 24 and prevents food particles from entering the floss channel 10.

These embodiments are intended to define but not limit the invention.

1. An apparatus for flossing teeth comprising:
a frame having a body, a flossing section and a fulcrum channel; and
a first floss guide fixedly engaged with said frame at a first end of said flossing section; and
a second floss guide fixedly engaged with said frame at a second end of said flossing section; and
a pivot point disposed in said second floss guide; and
a lever hingedly engaged with said frame, proximal to said fulcrum channel, having an anchor point; and
a continuous length of floss looping around said anchor point, passing through said fulcrum channel, through said first floss guide, through said second floss guide, around said pivot point, again through said first floss guide, again through said fulcrum channel; said length of floss terminating at said anchor point; wherein
movement of said lever moves the length of floss over the pivot point such that two sections of the length of floss simultaneously move past one another, between said first and second floss guides, for purposes of shearing, breaking and removing debris from between teeth.

2. The apparatus of claim 1 wherein said lever is connected to said frame by way of a living hinge.

3. The apparatus of claim 1 wherein said frame further comprises a holding section.

4. The apparatus of claim 1 wherein said first floss guide and said second floss guide are ball-shaped.

5. The apparatus of claim 1 wherein said lever is paddle-shaped.

6. The apparatus of claim 1 wherein said two sections of the floss are twisted.

7. The apparatus of claim 1 wherein said pivot point is comprised of a pin.

8. The apparatus of claim 7 wherein said second floss guide has a recess configured to receive said pin; wherein said length of floss passes over said pin, and said pin head prevents lateral movement of said pin.
